(19) United States
(12) Patent Application Publication
(10) Pub. No.: US 2017/0085204 A1
(43) Pub. Date: Mar. 23, 2017

(54) SPEED CONTROL OF AN INDUCTION MOTOR

(71) Applicant: General Electric Company, Schenectady, NY (US)

(72) Inventor: Mark Anthony Didat, Floyds Knobs, IN (US)

(21) Appl. No.: 14/862,569

(22) Filed: Sep. 23, 2015

(51) Int. Cl. H02P 25/16; H02P 23/14; H02P 25/02

(52) U.S. Cl. CPC H02P 25/16; H02P 25/02; H02P 23/14

(57) ABSTRACT

Systems and methods are controlling an operating speed of an induction motor are provided. In particular, a current applied to a stator of an induction motor can be measured. A time domain representation of the measured current can be transformed into a frequency domain representation of the measured current. An operating speed of the induction motor can be determined based at least in part on the frequency domain representation. The determined speed can be compared to a desired operating speed, and the operating speed of the induction motor can be adjusted as necessary to meet the desired speed.

### FIELD OF THE INVENTION

The present subject matter relates generally to induction motors, and more particularly to systems and methods for controlling an operating speed of a phase controlled alternating current induction motor.

### BACKGROUND OF THE INVENTION

Induction motors are widely used in home appliances and other electromechanical systems. Induction motors typically produce torque to drive a load by applying a current to one or more stator windings to create a magnetic field. The magnetic field of the stator windings induces a current in a rotor, which in turn creates magnetic fields in the rotor that react against the magnetic field of the stator windings, and causes the rotor to rotate.

The speed of motor rotation is typically measured using one or more sensors associated with the induction motor. The sensed motor speed can be used, for instance, in a feedback loop to control the motor speed to meet a desired speed. Such sensor configurations can be difficult to implement, and can be prone to failure. For instance, such physical speed sensor configurations can require resources for design and implementation that add to the operational cost of the motor. Such sensor configurations can also exist in dynamic, harsh environments, which can create significant failure opportunities.

Accordingly, there is a need for efficient and reliable systems and methods of controlling operating speeds of an induction motor.

### BRIEF DESCRIPTION OF THE INVENTION

Aspects and advantages of embodiments of the present disclosure will be set forth in part in the following description, or may be learned from the description, or may be learned through practice of the embodiments.

One example aspect of the present disclosure is directed to a method of determining a speed of an induction motor. The method includes obtaining data indicative of an amount of current drawn by an alternating current induction motor. The method further includes determining frequency data associated with the alternating current induction motor based at least in part on the obtained data indicative of the current drawn by the alternating current induction motor. The method further includes determining a measured operating speed of the alternating current induction motor based at least in part on the determined frequency data. The method further includes comparing the measured operating speed of the alternating current induction motor to a desired operating speed of the alternating current induction motor. The method further includes controlling the operating speed of the alternating current induction motor based at least in part on the comparison.

Another example aspect of the present disclosure is directed to an induction motor including a rotor, a stator, a current sensor coupled to the stator. The current sensor is configured to measure an amount of current applied to the stator. The induction motor further includes a control system configured to selectively control an operating speed of the induction motor by receiving a signal indicative of the measured current from the current sensor, transforming the signal indicative of the measured current to a frequency domain representation of the measured current, determining a measured operating speed of the induction motor based at least in part on the frequency domain representation of the measured current, comparing the measured operating speed of the induction motor to a desired operating speed of the induction motor, controlling the operating speed of the induction motor based at least in part on the comparison of the measured operating speed to the desired operating speed.

Yet another example aspect of the present disclosure is directed to a control system including one or more memory devices and one or more processors storing computer-readable instructions that when executed by the one or more processors cause the one or more processors to perform operations. The operations include receiving, from a current sensor, a time domain representation of a current applied to a stator of an induction motor. The operations further include transforming the time domain representation of the current to a frequency domain representation of the current. The operations further include determining an operating speed of the induction motor based at least in part on the frequency domain representation of the current. The operations further include comparing the determined operating speed of the induction motor to a desired operating speed of the induction motor.

Variations and modifications can be made to these example embodiments of the present disclosure.

These and other features, aspects and advantages of various embodiments will become better understood with reference to the following description and appended claims. The accompanying drawings, which are incorporated in and constitute a part of this specification, illustrate embodiments of the present disclosure and, together with the description, serve to explain the related principles.

### BRIEF DESCRIPTION OF THE DRAWINGS

Detailed discussion of embodiments directed to one of ordinary skill in the art are set forth in the specification, which makes reference to the appended figures, in which:

FIG. 1 depicts an overview of an example system for controlling an operating speed of an induction motor according to example embodiments of the present disclosure;

FIG. 2 depicts a plot of an example current signal applied to an induction motor according to example embodiments of the present disclosure;

FIG. 3 depicts a plot of an example frequency response of a current signal applied to an induction motor according to example embodiments of the present disclosure; and

FIG. 4 depicts a flow diagram of an example method of controlling an operating speed of an induction motor according to example embodiments of the present disclosure.

### DETAILED DESCRIPTION OF THE INVENTION

Reference now will be made in detail to embodiments of the invention, one or more examples of which are illustrated in the drawings. Each example is provided by way of explanation of the invention, not limitation of the invention. In fact, it will be apparent to those skilled in the art that various modifications and variations can be made in the present invention without departing from the scope or spirit of the invention. For instance, features illustrated or described as part of one embodiment can be used with another embodiment to yield a still further embodiment. Thus, it is intended that the present invention covers such modifications and variations as come within the scope of the appended claims and their equivalents.

Example aspects of the present disclosure are directed to systems and methods of controlling an operating speed of a line fed, phase controlled induction motor. For instance, a current applied to the induction motor may be monitored. A signal indicative of the current may be transformed into a frequency domain representation of the current. The frequency domain representation may be analyzed to determine an operating speed of the induction motor, which can be compared against a desired operating speed. The operating speed of the induction motor can then be adjusted as necessary to meet the desired operating speed.

More particularly, the induction motor can be a line fed, phase controlled induction motor. The induction motor can be a single-phase induction motor or a multi-phase induction motor, such as a three-phase induction motor. An alternating current can be applied to a stator of the motor to produce a magnetic field, which in turn can induce a current in a rotor of the motor. The induced rotor current can also produce a magnetic field, which can interact with the magnetic field of the stator thereby producing a torque causing the rotor to rotate. In embodiments wherein the induction motor is a single-phase induction motor, the stator can include a main winding and an auxiliary winding spaced 90 electrical degrees apart. The main and auxiliary windings can be configured to create a rotational magnetic field, which can cause an initial rotation by the rotor. The speed of the rotation can be determined based at least in part on the current applied to the stator.

In this manner, the alternating current applied to the stator of the induction motor can be monitored using a current sensing device. Such current sensing device can include a resistor, a current transducer, a current transformer, a Hall-effect device and/or other suitable current sensing device. A time domain representation of the current can be obtained using the current sensing device. In example embodiments, the current can be sampled for one or more suitable time periods using an analog-to-digital converter (ADC) in order to convert the analog current signal obtained by the current sensing device to a discrete, digital signal. The time domain representation of the current signal can be transformed to a frequency domain representation of the current signal. It will be appreciated that the transformation can be performed using various suitable transformation techniques, such as for instance, a Fourier transform, a discrete Fourier transform, a fast Fourier transform, a short time Fourier transform, a wavelet transform, or other suitable transformation technique.

The frequency domain representation of the current signal can include one or more magnitude peaks specifying a representation of one or more frequencies of the current signal. For instance, the frequency domain representation of the current signal can include a magnitude peak corresponding to a fundamental frequency of the current signal, such as 60 Hertz (Hz) or other frequency. The frequency domain representation can further include one or more additional magnitude peaks, such as one or more sideband peaks. At least one of the sideband peaks can correspond to an operating speed of the induction motor. In particular, at least one sideband peak can correspond to a slip frequency. Slip frequency can correspond to the difference between the synchronous speed of the induction motor and the rotational speed of the rotor. In this manner, the slip frequency can be used to determine the rotational speed of the rotor (e.g. the operating speed of the induction motor).

In example embodiments, the operating speed of the motor can be controlled based at least in part on the determined operating speed. For instance, the determined operating speed can be provided to a control device associated with the induction motor. The determined operating speed can then be compared against a desired operating speed for a particular task, application, or operation. The operating speed of the induction motor can then be controlled based at least on the comparison. For instance, the control device can use one or more algorithms to adjust a voltage applied to the motor to meet the desired speed.

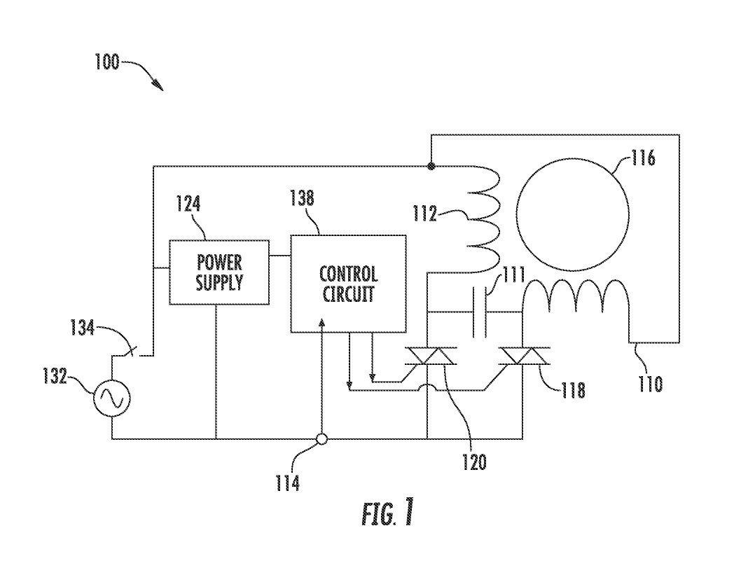

With reference now to the Figures, example embodiments of the present disclosure will be discussed in further detail. For instance, FIG. 1 depicts a schematic of an example induction motor control system 100. More particularly, FIG. 1 illustrates a circuit diagram of one embodiment of an electronic start motor and associated circuitry as may be used to implement the present subject matter. As part of a stator, a start winding 110 is coupled in parallel with a run winding 112 for providing torque to a rotor 116. In the presently illustrated embodiment both windings are further coupled to a power supply 124 through a control circuit 138. Power supply 124 is configured to receive an input voltage from AC source 132, such as 110 volts, through a switch 134, and to supply a DC voltage to control circuit 138 to provide operating power for control circuit 138.

Start winding 110 and run winding 112 are coupled to control circuit 138 through switches shown as start Triac 118 and run Triac 120. Triacs 118 and 120 may be switched off when the load current is close to zero. In this manner, Triacs 118 and 120 may be used to respectively connect and disconnect start winding 110 and run winding 112 to and from power source 132. It will be appreciated that the illustration of Triacs 118 and 120 is for example only. Various other switches, such as, but not limited to field effect transistors, and/or back to back SCR configurations can alternatively be used, if desired. In example embodiments, start winding 110 may be coupled to a capacitor 111 to provide the phase shift necessary for starting the motor.

A current sensor 114 is coupled to the start and run windings 110, 112 by way of being placed in the common power line connecting the windings to power source 132. In one embodiment, the current sensor may correspond to a resistor of appropriate size, such as 0.1 ohm, coupled to control circuit 138, for example, in a configuration which measures the voltage drop across the resistor. In some embodiments, current sensor 114 is coupled to a portion of the control circuit containing an analog-to-digital (A/D) converter 122, to convert the voltage across the resistor to a digital voltage signal. Alternatively, current sensor 114 may correspond to a current transformer coupled to the common power line connecting Triacs 118, 120 to power source 132. Other current sensors including, but not limited to, current transducers or Hall effect type devices may be employed. As will be described in greater detail below, current sensor 114 can be configured to monitor an alternating current applied to the stator winding(s) and to provide a signal indicative of the monitored current to control circuit 138 for use in current signature analysis.

Control circuit 138 can include one or more processor(s) and one or more memory device(s) configured to perform a variety of computer-implemented functions and/or instructions (e.g., performing the methods, steps, calculations and the like and storing relevant data as disclosed herein). The instructions when executed by the processor(s) can cause the processor(s) to perform operations according to example aspects of the present disclosure.

Additionally, the control circuit 138 can include a communications module to facilitate communications between the controller and the various components of the system 100. Further, the communications module can include a sensor interface (e.g., one or more analog-to-digital converters, such as A/D 122) to permit signals transmitted from one or more sensors to be converted into signals that can be understood and processed by the processors. It should be appreciated that the sensors (e.g. current sensor 114) can be communicatively coupled to the communications module using any suitable means, such as a wired or wireless connection. The signals can be communicated using any suitable communications protocol. As such, the processor(s) can be configured to receive one or more signals from current sensor 114, or other sensor. For instance, the processor(s) can receive signals indicative of an amount of current being applied to the stator windings 110, 112.

As used herein, the term “processor” refers not only to integrated circuits referred to in the art as being included in a computer, but also refers to a controller, a microcontroller, a microcomputer, a programmable logic controller (PLC), an application specific integrated circuit, and other programmable circuits. Additionally, the memory device(s) can generally include memory element(s) including, but not limited to, computer readable medium (e.g., random access memory (RAM)), computer readable non-volatile medium (e.g., a flash memory), a compact disc-read only memory (CD-ROM), a magneto-optical disk (MOD), a digital versatile disc (DVD) and/or other suitable memory elements. Such memory device(s) can generally be configured to store suitable computer-readable instructions that, when implemented by the processor(s), configure the control circuit 138 to perform the various functions as described herein.

It will be appreciated that the induction motor system 100 depicted in FIG. 1 is for illustrative purposes only. It will further be appreciated that various other suitable induction motor control systems can be used without deviating from the scope of the present disclosure. For instance, such suitable induction motor systems may include wound type induction motors, squirrel-cage induction motors, three phase induction motors, or various other suitable induction motors having various suitable configurations and/or control circuitries.

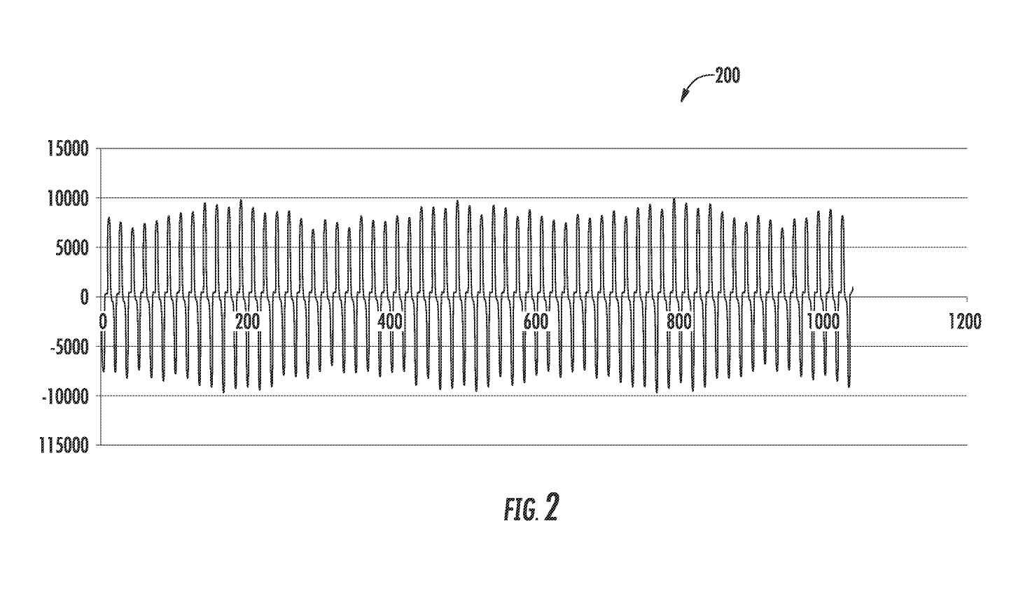

FIG. 2 depicts a plot of an example current signal 200 applied to an AC induction motor. In particular, current signal 200 is a time domain representation of a current applied to the stator winding(s) of an AC induction motor. In this manner, current signal 200 specifies amplitude of the applied current with respect to time. Current signal 200 can be sensed using a current sensing device, such as current sensor 114 of FIG. 1.

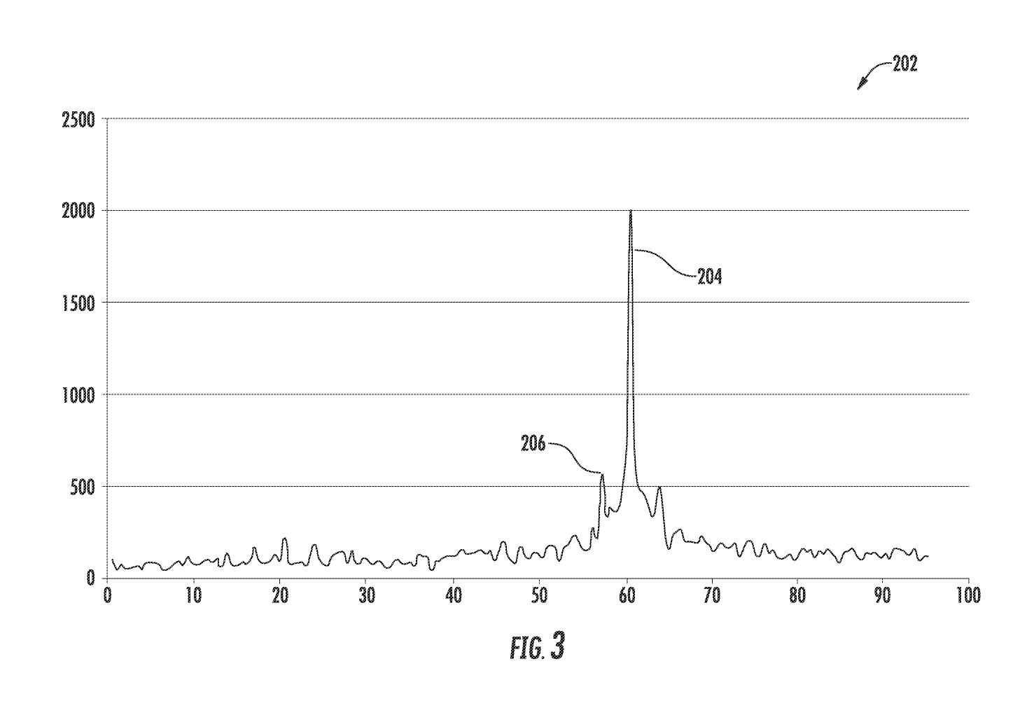

Current signal 200 can be transformed from a time domain representation into a frequency domain representation. For instance, FIG. 3 depicts a frequency domain representation 202 of current signal 200. In particular, frequency domain representation 202 depicts a Fourier transform of current signal 200. It will be appreciated that the frequency domain representation 202 can be determined using various other suitable transformation techniques, such as for instance, a wavelet transformation technique. Frequency domain representation 202 includes one or more peaks including fundamental frequency peak 204, and sideband peak 206. As shown, fundamental frequency peak 204 is located at about 60 Hz, which can correspond to a supply frequency of the alternating current provided to the induction motor.

As indicated above, sideband peak 206 can correspond to a slip frequency and/or rotor frequency of the induction motor. In this manner, an operating speed of the induction motor can be determined from sideband peak 206. The operating speed of the induction motor can correspond to the rotational rotor speed of the induction motor. As will be described in more detail below, the operating speed determined from frequency domain representation 202 can be compared against a desired operating speed, and the operating speed of the induction motor can be adjusted based at least in part on the comparison.

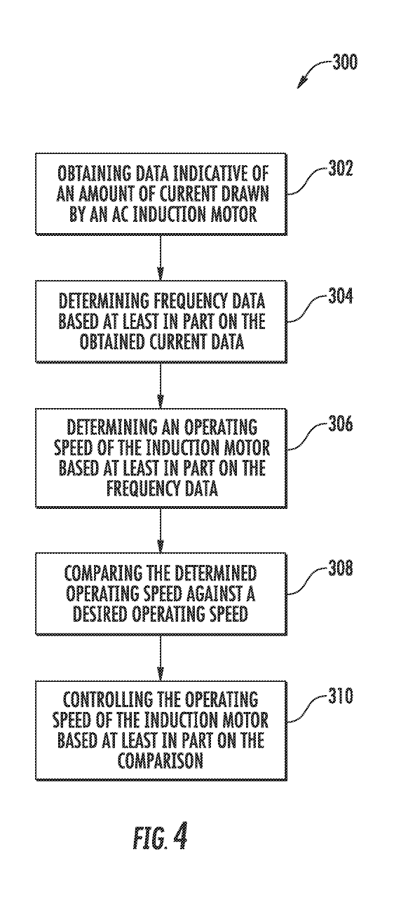

FIG. 4 depicts a flow diagram of an example method (300) of controlling an operating speed of an induction motor according to example embodiments of the present disclosure. The method (300) can be implemented by one or more computing devices, such as one or more of the computing devices disclosed herein. In addition, FIG. 4 depicts steps performed in a particular order for purposes of illustration and discussion. Those of ordinary skill in the art, using the disclosures provided herein, will understand that the steps of any of the methods disclosed herein can be modified, adapted, expanded, omitted, and/or rearranged in various ways without deviating from the scope of the present disclosure.

At (302), method (300) can include obtaining data indicative of an amount of current drawn by an induction motor. In example embodiments, the induction motor can be a line fed, phase controlled induction motor. The induction motor can be a single-phase induction motor or a multi-phase induction motor, such as a three-phase induction motor. The current data can be obtained using a current sensor, such as an appropriately sized resistor, a current transformer, current transducer, Hall-effect device, or other suitable current sensor. In embodiments wherein a three-phase induction motor is used, current can be sensed on an individual phase line of the induction motor.

As described above, the current data can be a time domain representation of the sensed current. In example embodiments, the sensed current can be sampled by an analog-to-digital converter for one or more time periods at one or more sampling frequencies to generate a digital current signal.

At (304), method 300 can include determining frequency data based at least in part on the obtained current data. The frequency data can be determined by transforming the time domain representation of the current into a frequency domain representation (e.g. frequency response) of the current. In this manner, the sensed current can be determined or otherwise plotted with respect to frequency. For instance, the frequency domain representation can be determined using a Fourier transform, a discrete Fourier transform, a fast Fourier transform, a wavelet transform, or other suitable transformation technique.

As described above, the frequency domain can include one or more peaks indicative of a frequency magnitude. For instance, the frequency domain representation can include a fundamental frequency peak. The fundamental frequency peak can approximately correspond to the frequency of the supply current provided to the induction motor. For instance, the fundamental frequency peak can be located at 60 Hz, 50 Hz, or other frequency.

The frequency domain representation can further include one or more sideband peaks having a magnitude that is smaller than the fundamental frequency peak. For instance, at least one sideband peak can correspond to a slip frequency. The at least one sideband peak can result from the operating speed of the motor (e.g. rotational rotor speed) being less than the synchronous speed of the motor. In example embodiments, the at least one sideband peak can correspond to the peak having the largest magnitude outside of the fundamental frequency peak or any harmonic frequency peaks.

At (306), method (300) can include determining an operating speed of the induction motor based at least in part on the frequency data. In particular, the operating speed of the induction motor can be determined based at least in part on the slip frequency sideband. In example embodiments, when the rotational rotor speed lags the synchronous speed of the motor, the operating speed can be less than the synchronous speed by an amount corresponding to the slip frequency of the motor.

At (308), method (300) can include comparing the determined operating speed against a desired operating speed. The desired operating speed can be any suitable operating speed to meet a desired application or task. In particular, the determined operating speed can be analyzed in view of the application or task to determine whether the operating speed of the motor is equal to the desired operating speed suitable for the application or task.

At (310), method (300) can include controlling the operating speed of the induction motor based at least in part on the comparison. For instance, the operating speed of the induction motor can be increased or decreased to meet the desired operating speed. In example embodiments, the operating speed can be controlled by adjusting a voltage applied to the induction motor. For instance, the voltage can be adjusted using one or more control algorithms, such as a PI algorithm, a PID, algorithm, or other suitable algorithm.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

1. A method of determining a speed of line fed phase controlled induction motor, the method comprising:
obtaining data indicative of an amount of current drawn by an alternating current induction motor;
determining frequency data associated with the alternating current induction motor based at least in part on the obtained data indicative of the current drawn by the alternating current induction motor;
determining a measured operating speed of the alternating current induction motor based at least in part on one or more sideband peaks associated with the determined frequency data;
comparing the measured operating speed of the alternating current induction motor to a desired operating speed of the alternating current induction motor; and
controlling the operating speed of the alternating current induction motor based at least in part on the comparison.

2. The method of claim 1, wherein the data indicative of the current drawn by the alternating current induction motor comprises a time domain representation of the amount of current drawn by the alternating current induction motor.

3. The method of claim 2, wherein determining frequency data associated with alternating current induction motor comprises transforming the time domain representation of the amount of current drawn by the alternating current induction motor into a frequency domain representation of the amount of current drawn by the alternating current induction motor.

4. The method of claim 3, wherein the frequency domain representation is determined using a Fourier transform.

5. The method of claim 3, wherein the frequency domain representation is determined using a wavelet transform.

6. The method of claim 1, wherein the induction motor is a line fed phase controlled induction motor.

7. The method of claim 1, wherein the frequency data comprises a signal having one or more peaks indicative of one or more frequencies associated with the current drawn by the alternating current induction motor.

8. The method of claim 7, wherein the one or more peaks comprise a fundamental frequency peak and one or more sideband peaks.

9. The method of claim 8, wherein at least one of the one or more sideband peaks correspond to a slip frequency associated with the alternating current induction motor.

10. The method of claim 9, wherein the operating speed of the alternating current induction motor is determined based at least in part on the one or more sidebands corresponding to the slip frequency.

11. The method of claim 1, wherein controlling the operating speed of the alternating current induction motor based at least in part on the comparison comprises adjusting a voltage applied to the alternating current induction motor.

12. A line fed phase controlled induction motor comprising:
a rotor;
a stator;
a current sensor coupled to the stator configured to measure an amount of current applied to the stator; and
a control system configured to selectively control an operating speed of the induction motor by:
receiving a signal indicative of the measured current from the current sensor;
transforming the signal indicative of the measured current to a frequency domain representation of the measured current;
determining a measured operating speed of the induction motor based at least in part on one or more sideband peaks associated with the frequency domain representation of the measured current;
comparing the measured operating speed of the induction motor to a desired operating speed of the induction motor; and
controlling the operating speed of the induction motor based at least in part on the comparison of the measured operating speed to the desired operating speed.

13. The induction motor of claim 12, wherein controlling the operating speed of the induction motor based at least in part the comparison of the determined operating speed to the desired operating speed comprises adjusting a voltage signal applied to the induction motor.

14. The induction motor of claim 12, wherein the current sensor is further configured to provide a signal indicative of the measured current to the control system.

15. The induction motor of claim 14, wherein the signal indicative of the measured current comprises a time domain representation of the amount of current applied to the stator.

16. The induction motor of claim 12, wherein the signal indicative of the measured current is transformed into the frequency domain representation of the measured current using a Fourier transform or a wavelet transform.

17. A control system comprising:
one or more memory devices; and
one or more processors, the processors storing computer-readable instructions that when executed by the one or more processors cause the one or more processors to perform operations, the operations comprising:
receiving, from a current sensor, a time domain representation of a current applied to a stator of a line fed phase controlled induction motor;
transforming the time domain representation of the current to a frequency domain representation of the current;
determining an operating speed of the induction motor based at least in part on one or more sideband peaks associated with the frequency domain representation of the current; and
comparing the determined operating speed of the induction motor to a desired operating speed of the induction motor.

18. The control system of claim 17, the operations further comprising controlling the operating speed of the induction motor based at least in part on the comparison of the determined operating speed to the desired operating speed.

19. The control system of claim 17, wherein the frequency domain representation of the current comprises a fundamental frequency peak, and one or more sideband peaks.

20. The control system of claim 19, wherein the operating speed of the induction motor is determined at least in part from at least one of the one or more sideband peaks.
